(19) United States
(12) Patent Application Publication
(10) Pub. No.: US 2014/0365347 A1
(43) Pub. Date: Dec. 11, 2014

(54) USING COMMERCE NETWORKS TO FACILITATE BUSINESS INTERACTIONS AMONG ENTITIES

(71) Applicant: INTUIT INC., Mountain View, CA (US)

(72) Inventors: Calum G. Murray, Santa Rosa, CA (US); John J. Tumminaro, Palo Alto, CA (US); Jeffrey A. Langston, Palo Alto, CA (US)

(21) Appl. No.: 13/911,890

(22) Filed: Jun. 6, 2013

(51) Int. Cl. G06Q 40/00

(52) U.S. Cl. CPC G06Q 40/12
USPC 705/30

(57) ABSTRACT

The disclosed embodiments provide a system that facilitates business interaction. During operation, the system obtains a model of a commerce network containing a set of entities, a set of relationships among the entities, a set of interactions related to commerce among the entities, and a set of activities associated with the entities. Next, the system uses the model to enable an interaction among two or more entities from the set of entities independently of a set of endpoints used by the entities to access the commerce network.

### RELATED APPLICATION

The subject matter of this application is related to the subject matter in a co-pending non-provisional application by inventor Calum G. Murray and filed on the same day as the instant application entitled “Unauthenticated Access to Artifacts in Commerce Networks,” having serial number TO BE ASSIGNED, and filed on 6 Jun. 2013 (Attorney Docket No. INTU-137285).

### BACKGROUND

### Related Art

The disclosed embodiments relate to commerce networks. More specifically, the disclosed embodiments relate to techniques for facilitating business interactions among entities in a commerce network.

Financial-management applications may be used by individuals, small businesses, and/or organizations to perform financial transactions and/or manage finances. For example, a small business owner may use business-accounting software to generate payrolls, track inventory, manage invoices, track financial transactions, and/or generate reports. Similarly, an individual may use a tax-preparation application to prepare and file income taxes.

During use of such financial-management applications, financial transactions may be carried out by transmitting, exchanging, and/or processing data (e.g., invoices, estimates, purchase orders, etc.) related to the financial transactions. However, the use of different applications, platforms, and/or communications mechanisms by different participants in the financial transactions may increase the overhead associated with performing the financial transactions.

For example, a business owner and a customer may use different business-accounting applications to manage finances and/or financial transactions. To obtain payment for goods or services rendered to the customer, the business owner may generate an invoice using a first business-accounting application and manually send the invoice to the customer over email. Upon receiving the email, the customer may download the invoice and/or view the invoice within a web browser and/or document viewer. Next, the customer may store a copy of the invoice in a second business-accounting application and use information from the invoice to mail and/or electronically transfer a payment to the business owner. Finally, the business owner may update his/her accounting records within the first business-accounting application with the payment, and the customer may independently update his/her accounting records within the second business-accounting application with the payment. In other words, multiple manual steps may be performed by both the business owner and customer to accommodate the inability of the two business-accounting applications to communicate with one another, thus increasing the complexity, time, effort, and/or user error associated with processing and paying the invoice.

Consequently, financial management may be facilitated by integrating mechanisms for performing financial transactions and/or exchanging data associated with the financial transactions.

### SUMMARY

The disclosed embodiments provide a system that facilitates business interaction. During operation, the system obtains a model of a commerce network containing a set of entities, a set of relationships among the entities, a set of interactions related to commerce among the entities, and a set of activities associated with the entities. Next, the system uses the model to enable an interaction among two or more entities from the set of entities independently of a set of endpoints used by the entities to access the commerce network.

In some embodiments, the system also updates the model based on an activity associated with the interaction.

In some embodiments, the system also uses the updated model to enable one or more subsequent interactions among the two or more entities.

In some embodiments, enabling the interaction among the two or more entities involves at least one of:
(i) generating a notification associated with the interaction;
(ii) routing the notification to one or more of the endpoints based on the model; and
(iii) routing the interaction to the one or more of the endpoints based on the model.

In some embodiments, the set of entities includes at least one of an individual, an organization, and a representative of the organization.

In some embodiments, the set of relationships includes at least one of an explicit relationship, an implicit relationship, and a latent relationship. The explicit relationship is declared by an entity from the set of entities, the implicit relationship is formed by one or more of the interactions, and the latent relationship is based on analysis of the model.

In some embodiments, the set of endpoints includes at least one of a consumer endpoint, a business endpoint, an external endpoint, and a generic endpoint.

In some embodiments, the generic endpoint enables access to the commerce network by a non-registered entity.

In some embodiments, the interaction is associated with an exchange of an artifact among the two or more entities.

### BRIEF DESCRIPTION OF THE FIGURES

FIG. 1 shows a schematic of a system in accordance with the disclosed embodiments.

FIG. 2 shows an exemplary set of components in a model of a commerce network in accordance with the disclosed embodiments.

FIG. 3 shows a system for facilitating business interaction in accordance with the disclosed embodiments.

FIG. 4 shows an exemplary timeline of a series of interactions between two entities of a commerce network in accordance with the disclosed embodiments.

FIG. 5 shows a flowchart illustrating the process of facilitating business interaction in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

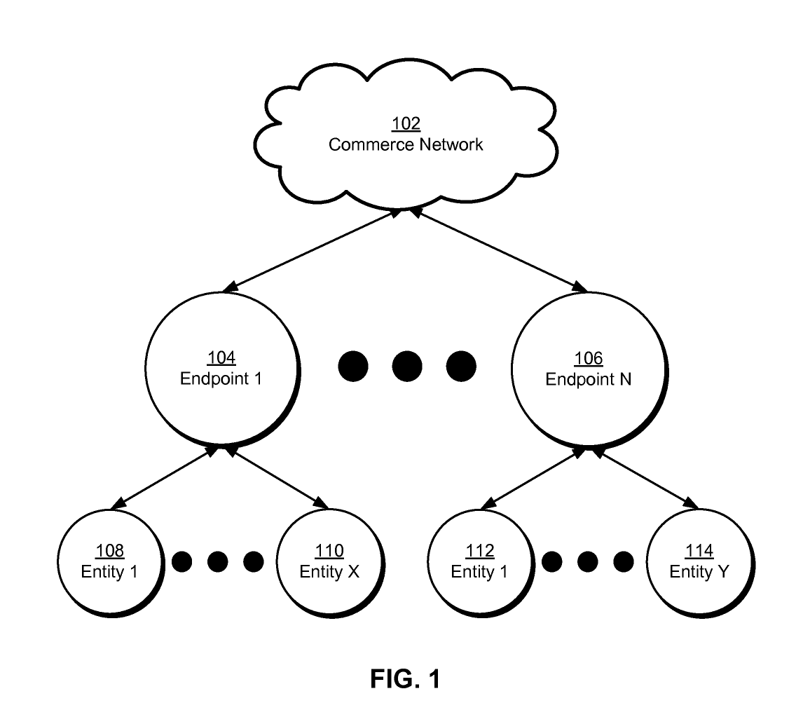

The disclosed embodiments provide a method and system for facilitating business interaction. As shown in FIG. 1, the business interaction may be conducted through a set of endpoints (e.g., endpoint 1 104, endpoint n 106) of a commerce network 102 by one or more sets of entities (e.g., entity 1 108, entity x 110, entity 1 112, entity y 114). Each entity may represent an individual, an organization (e.g., small business, company, non-profit organization, etc.), and/or a representative of the organization. In addition, the entities may use the endpoints and commerce network 102 to manage employees and payroll, generate and pay invoices, order inventory, file taxes, track accounts, and/or perform other operations related to financial transactions and/or commerce.

Each endpoint may provide an application, system, and/or platform used by a set of entities to manage finances and/or conduct financial transactions. For example, the endpoint may be a natively installed, mobile, and/or web-based accounting application, tax-preparation application, investment-management application, contract- and/or spend-management application, customer-relationship-management application, enterprise resource planning (ERP) system, and/or other type of software system that facilitates management of business and/or financial interactions for entities using the software system.

The endpoint may also provide an interface for accessing commerce network 102. For example, the endpoint may connect to a set of services provided by commerce network 102 to facilitate commerce and/or business interactions (e.g., financial transactions) with entities at other endpoints of commerce network 102. In turn, commerce network 102 may connect the endpoints and allow the commerce and/or business interactions to occur across the endpoints. For example, commerce network 102 may aggregate data associated with the entities and interactions from the endpoints, enable access to the data by entities involved in the interactions through the endpoints, and/or allow the entities to interact through different endpoints.

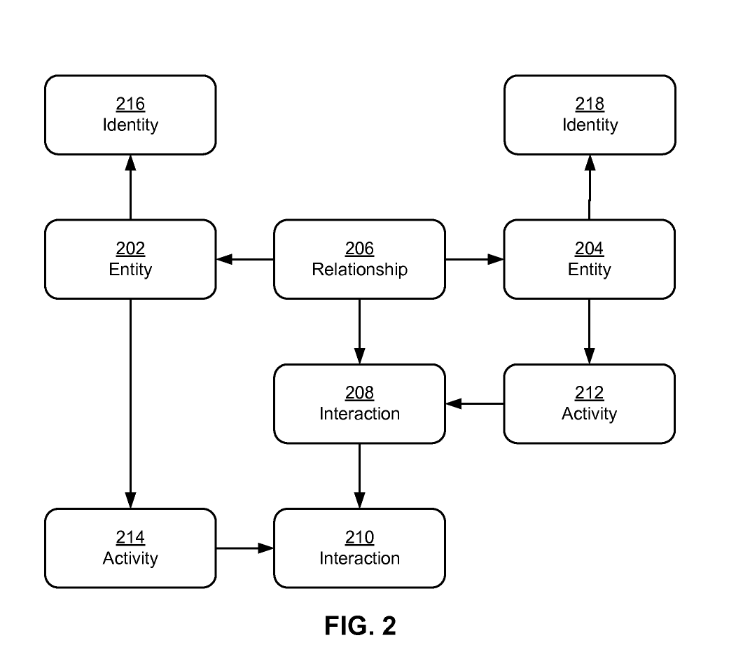

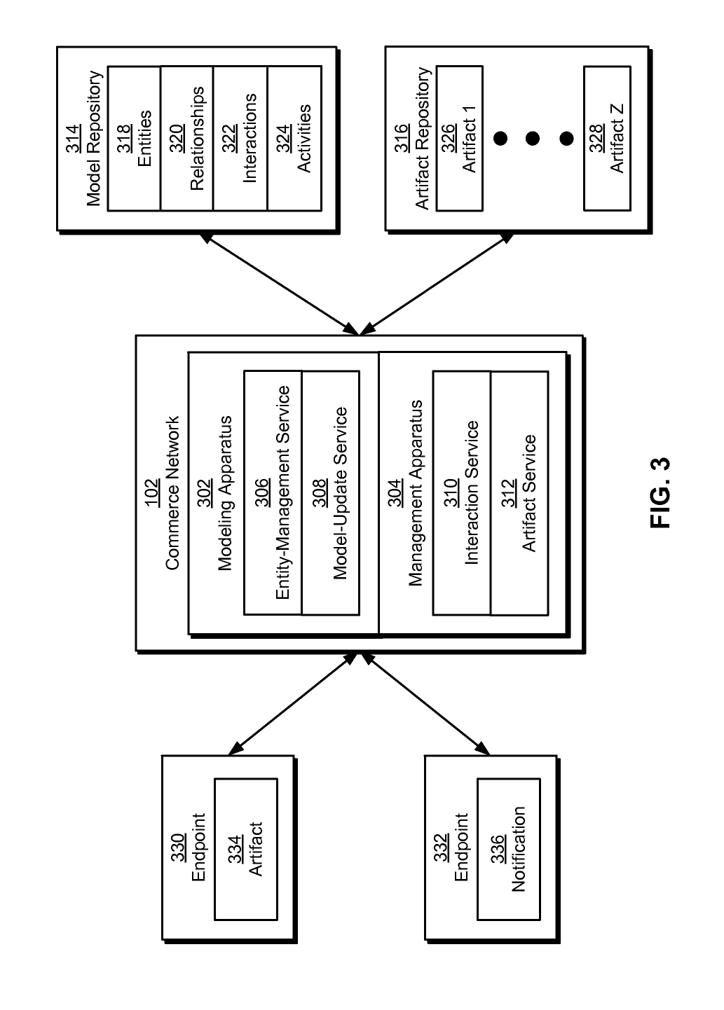

In one or more embodiments, data associated with the entities, endpoints, and/or interactions is stored in a model of commerce network 102. As discussed in further detail below with respect to FIG. 2, the model may include unique identities for the entities, relationships among the entities, interactions related to commerce among the entities, and/or a set of activities associated with the entities. The model may then be updated based on the interactions and/or used to enable interactions among the entities across the endpoints, as discussed in further detail below with respect to FIG. 3.

FIG. 2 shows an exemplary set of components in a model of a commerce network (e.g., commerce network 102 of FIG. 1) in accordance with the disclosed embodiments. As shown in FIG. 2, the model may include a set of entities 202-204, a relationship 206 between entities 202-204, a set of interactions 208-210 related to commerce between entities 202-204, and a set of activities 212-214 associated with entities 202-204.

The model may be represented as a graph with entities 202-204, relationship 206, interactions 208-210, and/or activities 212-214 as nodes that are connected by edges. The model may be created and/or updated by batch-processing data from the endpoints and/or obtaining the data from the endpoints in real-time (e.g., as the commerce network is used).

As mentioned above, entities 202-204 may represent individuals, organizations, and/or representatives of the organizations. For example, entities 202-204 may include names, descriptions, contact information, and/or other details associated with the corresponding individuals, organizations, and/or representatives. Details associated with entities 202-204 may be obtained from the endpoints used by entities 202-204. In addition, the representation of a particular individual, organization, and/or representative by each entity 202-204 may be associated with a level of “confidence,” which is adjusted based on information known about the entity and/or use of the commerce network by the entity.

Each entity 202-204 is associated with a unique identity 216-218 that distinguishes the entity from other entities in the model and/or commerce network. For example, each identity 216-218 may include a unique identifier (ID) and/or authentication context for the corresponding entity. The unique ID may be linked to unique IDs in external networks and/or endpoints to enable interactions (e.g., interactions 208-210) among multiple networks. To facilitate verification of the identity, the unique ID may also be linked to a standardized and/or well-known identifier such as a Taxpayer Identification Number (TIN) and/or Data Universal Numbering System (DUNS) number. The identity may then be used to manage access to services and/or data in the commerce network by the entity. In other words, identities 216-218 may be used in identity and access management (IAM) of entities 202-204.

Relationship 206 may establish a link between entities 202-204. In addition, relationship 206 may be explicit, implicit, or latent. An explicit relationship 206 between entities 202-204 may be declared by one or both entities 202-204 during use of the commerce network and/or one or more endpoints of the commerce network. For example, one or both entities 202-204 may explicitly label the other entity as a friend, contact, acquaintance, family member, customer, employer, business associate, and/or vendor. The explicitly declared relationship may also be confirmed by the other entity before the relationship is labeled as explicit within the model.

On the other hand, an implicit relationship 206 may be formed through interactions 208-210 between entities 202-204. For example, an implicit relationship may be established after an invoice, payment, message, estimate, and/or other information is transmitted between entities 202-204. The implicit relationship may also be based on historical interactions between entities 202-204.

Finally, a latent relationship 206 between entities 202-204 may be implied based on relationships and/or interactions between entities 202-204 and/or other entities in the commerce network, as indicated through analysis of the model. For example, entities 202-204 may have a latent relationship if entities 202-204 share relationships with a large number of other entities in the commerce network and/or frequently interact with the same entities in the commerce network.

Interactions 208-210 are associated with the exchange of one or more artifacts between entities 202-204. For example, interactions 208-210 may include the transmission and/or exchange of invoices, payments, estimates, receipts, emails, messages, chats, purchase orders, reviews, and/or other information or documents between entities 202-204. To carry out an interaction from interactions 208-210, an artifact and/or identifying information for one or more target entities may be obtained from an entity initiating the interaction. Next, the identifying information may be matched to the target entities and/or identities of the target entities in the model, and access to the artifact may be enabled for the target entities, as described in further detail below with respect to FIG. 3.

As described above, interactions 208-210 may be used to establish relationship 206. Interactions 208-210 may also be used to modulate the “strength” of relationship 206. For example, a numeric value representing the strength of an explicit and/or implicit relationship 206 may increase with the number of interactions 208-210 and/or “important” interactions such as payments, receipts, and/or contracts. Conversely, the numeric value may be lower if entities 202-204 have fewer interactions and/or have interactions that are less “important” (e.g., messages, estimates, promotions, etc.).

Moreover, interactions 208-210 may be chained, in which one interaction (e.g., interaction 208) may result in an update of relationship 206 and the subsequent enabling of another interaction (e.g., interaction 210). For example, interaction 208 may include the exchange of an invoice between entities 202-204, thereby establishing relationship 206 between entities 202-204. After interaction 208 has completed, a subsequent interaction 210 involving the payment of the invoice may be enabled and/or conducted. The strength of relationship 206 may also be increased after each interaction 208-210, and subsequent interactions may be enabled based on the increase in the strength of relationship 206.

Finally, entities 202-204 may perform one or more activities 212-214 related to interactions 208-210 and/or use of the commerce network. In turn, activities 212-214 may be used to create, read, update, and/or delete other components of the model. For example, activity 212 may include the transmission of an invoice from entity 204 to entity 202, thus establishing interaction 208 and/or modifying one or more elements of relationship 206 and/or entities 202-204. In turn, activity 214 may include the payment of the invoice by entity 202, which establishes interaction 210 and/or further modifies one or more elements of relationship 206 and/or entities 202-204.

Conversely, entities 202-204 may take part in activities that are not related to interactions 208-210. For example, entities 202-204 may perform activities related to joining of the commerce network, accessing and/or using services provided by the commerce network, explicitly declaring relationship 206 and/or relationships with other entities, and/or filling in profiles for entities 202-204. The activities may be recorded and/or used to update entities 202-204, identities 216-218, and/or relationship 206.

FIG. 3 shows a system for facilitating business interaction in accordance with the disclosed embodiments. More specifically, FIG. 3 shows a system for enabling interaction among entities (e.g., entities 318) of commerce network 102 independently of a set of endpoints 330-332 used by the entities to access commerce network 102. As shown in FIG. 3, the system includes a modeling apparatus 302 and a management apparatus 304 within commerce network 102. Each of these components is described in further detail below.

Modeling apparatus 302 may be used to create, read, update, and/or delete components of a model of commerce network 102, such as the model of FIG. 2. As mentioned above, the model may be created and/or updated using historical data and/or real-time data from endpoints 330-332. The components may be stored in a model repository 314 as a set of entities 318, a set of relationships 320 among entities 318, a set of interactions 322 related to commerce among entities 318, and/or a set of activities 324 associated with entities 318. For example, entities 318, relationships 320, interactions 322, and/or activities 324 may be stored in a graph database, relational database, and/or other type of structured data storage.

Within modeling apparatus 302, an entity-management service 306 may manage entities 318 and the identities of entities 318. For example, entity-management service 306 may manage entities 318 representing individuals, organizations, and/or representatives of the organizations based on information obtained from endpoints 330-332 and/or commerce network 102 and/or use of endpoints 330-332 and/or commerce network 102 by the individuals, organizations, and/or representatives. Within each entity, entity-management service 306 may maintain a set of attributes and/or details for the entity, including a name, address, tax identifier, DUNS number, and/or other information for the identity. Entity-management service 306 may also aggregate the attributes and/or details from multiple endpoints 330-332 used by the entity so that a single view of the entity is shown within commerce network 102.

Modeling apparatus 302 may also include a model-update service 308 that enables use of the model with commerce network 102. For example, model-update service 308 may track relationships 320 and/or other interactions 322 based on entities 318 and/or activities 324 and allow endpoints 330-332 to access the model. Model-update service 308 may also expose relationships 320 as explicit, implicit, and/or latent; identify nodes and edges of the model; and perform merges and/or splits of the nodes while managing associated changes to relationships 320. In other words, model-update service 308 may enable use of the model by endpoints 330-332 and/or other parts of commerce network 102 while managing and/or updating the model based on use of commerce network 102 by entities 318.

Management apparatus 304 may use the model to enable an interaction among two or more entities from the set of entities 318 independently of endpoints 330-332 used by the entities to access commerce network 102. As described above, the interaction may involve the exchange of an artifact 334 among the entities. Artifact 334 may be a message, document, payment, email, and/or other attribute and/or information related to the interaction. Artifact 334 may be obtained from an entity initiating the interaction by an endpoint (e.g., endpoint 330) used by the entity to access commerce network 102.

An artifact service 312 may store artifact 334 in an artifact repository 316, along with other artifacts (e.g., artifact 1 326, artifact z 328) from other interactions within commerce network 102. For example, artifact service 312 may store the artifacts in a relational database, filesystem, and/or other structured storage mechanism for documents, messages, and/or data. Artifact service 312 may also manage the subsequent retrieval of the artifacts from artifact repository 316 during interactions and/or activities associated with the artifacts.

To enable the interaction, an interaction service 310 in management apparatus 304 may route the interaction and/or artifact 334 from a first entity initiating the interaction to one or more other entities targeted by the interaction. For example, interaction service 310 may use information from model-update service 308 to determine one or more endpoints associated with the targeted entities and transmit a notification 336 to the endpoint(s) (e.g., endpoint 332). Interaction service 310 may also maintain a record of the initiated interaction for subsequent analysis and/or use by modeling apparatus 302 in updating the model. Alternatively, interaction service 310 may prevent the interaction from occurring and/or omit notification 336 if model-update service 308 indicates that the first entity is fraudulent and/or otherwise not permitted to interact with the other entities.

After notification 336 is received by the other entities, the other entities may use notification 336 to access artifact 334. For example, the other entities may use a link in notification 336 to query artifact service 312 for artifact 334, and artifact service 312 may provide artifact 334 in response to the query if the other entities are granted access to artifact 334. On the other hand, interaction service 310 may transmit artifact 334 directly to the other entities in lieu of notification 336.

Activities associated with the interaction may then be used by modeling apparatus 302 to update the model. For example, transmission of artifact 334 from the first entity to commerce network 102 may be used to establish relationships between the first entity and the other entities, and retrieval of artifact 334 by the other entities may be used to strengthen the relationships. Information from artifact 334 may also be used to update attributes and/or details of the entity and/or other entities within the model.

Informational notifications related to activities in commerce network 102 may also be generated and transmitted to entities in commerce network 102 independently of the entities' participation in the activities. For example, changes to and/or announcements by an entity may trigger the transmission of notifications of the changes and/or announcements to entities that have subscribed to the notifications and/or have existing (e.g., explicit, implicit, and/or latent) relationships with the entity.

The updated model may then be used to enable one or more subsequent interactions among the entities. For example, management apparatus 304 may allow an entity that received an invoice in a previous interaction to pay the invoice in a subsequent interaction, ask a question related to the invoice, and/or request a revision of the invoice. Similarly, management apparatus 304 may allow an entity that received a message and/or question in a previous interaction to provide a response to the message and/or question in a subsequent interaction.

In one or more embodiments, endpoints 330-332 include a consumer endpoint, a business endpoint, an external endpoint, and/or a generic endpoint. The consumer endpoint may facilitate financial management and/or transactions for individual users of commerce network 102. For example, the consumer endpoint may allow individuals to manage personal finances, file taxes, and/or perform financial transactions related to the personal finances. On the other hand, the business endpoint may provide financial and/or business services for organizational users of commerce network 102. For example, the business endpoint may allow an organization and/or a representative of the organization to generate and/or manage invoices, payments, receipts, estimates, payroll, taxes, and/or other business and/or financial transactions for the organization.

The external endpoint may include a platform, system, and/or network that is independently developed and/or managed outside commerce network 102 but is connected to commerce network 102 using an interface. For example, the external endpoint may be a third-party application and/or service that accesses commerce network 102 and/or communicates with other endpoints of commerce network 102 through the interface. The inclusion of the external endpoint and entities using the external endpoint in commerce network 102 may facilitate interactions between the entities and other entities in commerce network 102, as well as an increase in value of commerce network 102 to all entities using commerce network 102.

The generic endpoint may facilitate the use of commerce network 102 by entities that are not currently registered with commerce network 102 and/or other endpoints of commerce network 102. For example, the generic endpoint may be used by a user who does not have an existing user account with a consumer endpoint, business endpoint, and/or external endpoint of commerce network 102.

In addition, a non-registered entity may be exposed to the generic endpoint in response to an interaction from an entity that is registered within commerce network 102. For example, the registered entity may initiate the interaction by providing an invoice and an email address of the non-registered entity. Interaction service 310 may enable the interaction by sending an email containing a link to the invoice to the email address, and entity-management service 306 may add the non-registered entity to the model. The non-registered entity may then use the link to access commerce network 102 through a web browser and obtain the invoice from artifact service 312. Finally, modeling apparatus 302 may update the model with subsequent use of commerce network 102 by the non-registered entity, such as payment of the invoice and/or registration of the non-registered entity with commerce network 102. In this way, the generic endpoint may facilitate viral growth in the number of registered entities in the commerce network, as well as use of the commerce network by the entities.

In one or more embodiments, commerce network 102 enables access to artifacts in interactions involving non-registered entities without requiring authentication of the non-registered entities. Such unauthenticated access may expedite completion of the interactions by the non-registered entities while maintaining access control for the artifacts. Enabling access to artifacts in interactions for non-registered entities is described in a co-pending non-provisional application by inventor Calum G. Murray and filed on the same day as the instant application entitled “Unauthenticated Access to Artifacts in Commerce Networks,” having serial number TO BE ASSIGNED, and filing date TO BE ASSIGNED (Attorney Docket No. INTU-137285), which is incorporated herein by reference.

The model may thus provide a mechanism for enabling interaction across multiple endpoints (e.g., endpoints 330-332) of commerce network 102, including interaction with non-registered entities and/or interaction between entities that lack a pre-existing relationship and/or history of interaction. Updates to the model based on the interaction and/or activities associated with the interaction may further facilitate use of commerce network 102 by enabling subsequent interaction among the entities and/or the receipt of notifications to changes in the entities and/or relationships. In addition, the use of endpoints to access commerce network 102 may allow endpoints to be added to commerce network 102 over time, thus increasing the capability and/or flexibility of commerce network 102. Finally, the model may be used to identify and/or develop insights into patterns and/or trends associated with the entities and/or the entities' behavior. For example, the model may be analyzed to determine valuable relationships and/or interactions among the entities, assess the entities' reputations, identify common attributes in an entity's relationships and/or interactions, and/or identify chains of relationships and/or interactions among the entities.

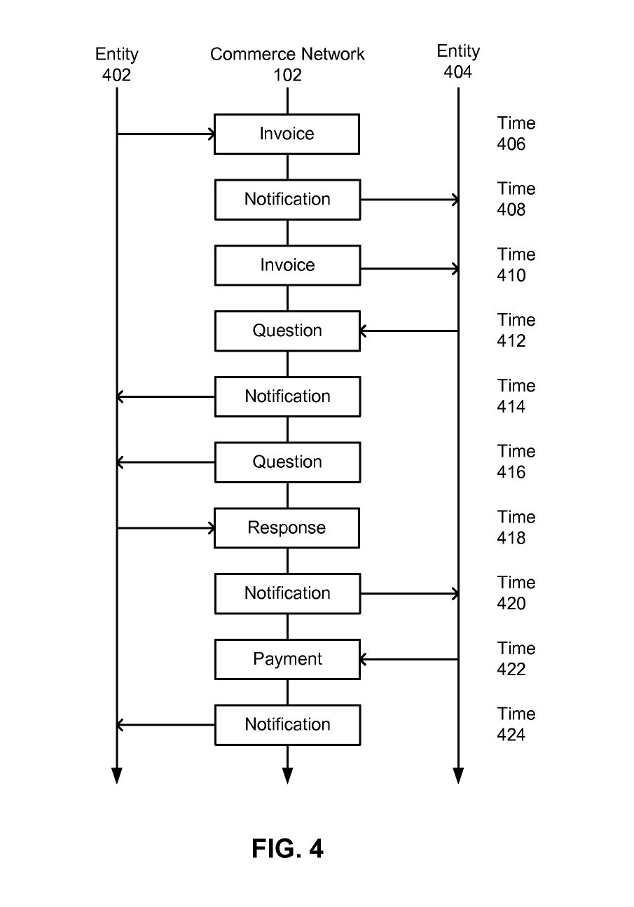

FIG. 4 shows an exemplary timeline of a series of interactions between two entities 402-404 of commerce network 102 in accordance with the disclosed embodiments. Entities 402-404 may be individuals, organizations, and/or representatives of the organizations that are engaged in commerce with one another. To facilitate the commerce, commerce network 102 may enable the interactions independently of a set of endpoints used by entities 402-404 to access commerce network 102.

Beginning with time 406, entity 402 may initiate an interaction by transmitting an invoice destined for entity 404 to commerce network 102. Commerce network 102 may store the invoice and use a model of commerce network 102 to transmit a notification of the invoice to entity 404 at time 408. To transmit the notification, commerce network 102 may obtain a name, email address, and/or other identifier for entity 404 from the interaction and match the identifier to entity 404 in the model. Commerce network 102 may then route the notification to entity 404 based on one or more endpoints used by entity 404. For example, commerce network 102 may send the notification as a message to an endpoint that is both used by entity 404 and most closely related to the endpoint used by entity 402 to send the invoice. Alternatively, if entity 404 is not registered with commerce network 102, commerce network 102 may transmit the notification as an email, text message, and/or other communication to the identifier for entity 404. Commerce network 102 may also route the notification based on criteria and/or priorities such as marketing goals, endpoint affinity, and/or cost.

At time 410, entity 404 may use the notification to retrieve the invoice from commerce network 102. For example, entity 404 may provide authentication credentials to the endpoint to which the notification is routed to access the notification. If the endpoint used by entity 404 to access the invoice is the generic endpoint, entity 404 may obtain the invoice from commerce network 102 without providing authentication credentials. Next, entity 404 may use a link in the notification to obtain the invoice from commerce network 102. After the invoice is obtained by entity 404, the interaction associated with transmitting the invoice may be complete.

At time 412, entity 404 may initiate a second interaction by providing a question to commerce network 102. Commerce network 102 may receive the question, generate a notification of the question, and route the notification to entity 402 at time 414. At time 416, entity 402 may use the notification to obtain the question from commerce network 102, thus completing the second interaction. Alternatively, commerce network 102 may transmit the question directly to entity 402 (e.g., through the endpoint used by entity 402) after receiving the question from entity 404.

At time 418, entity 402 may initiate a third interaction with entity 404 by providing a response to the question. At time 420, commerce network 102 may generate and route a notification of the response to entity 404. For example, commerce network 102 may transmit a message, email, and/or text message containing the response and details of the invoice to entity 404. Alternatively, commerce network 102 may include a link to the response and/or invoice within a notification, and entity 404 may use the link to access the response and/or invoice.

At time 422, entity 404 may initiate a fourth interaction by providing payment of the invoice to commerce network 102. The payment may be processed by commerce network 102, an automated payment system connected to commerce network 102 via an endpoint, and/or the endpoint used by entity 404 to access commerce network 102. Finally, at time 424, commerce network 102 may provide a notification of the payment to entity 402, thus concluding the fourth interaction.

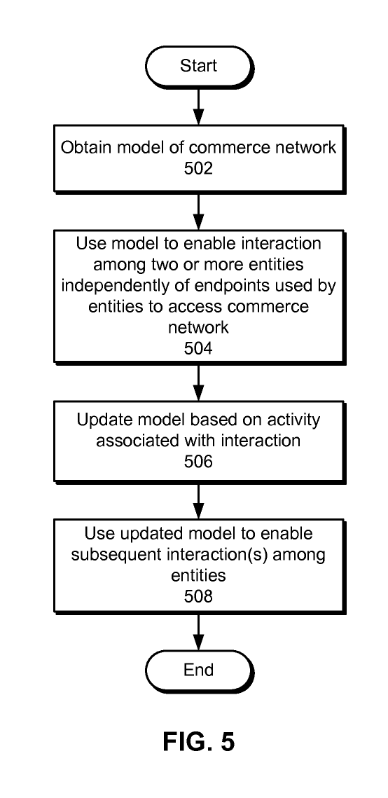

FIG. 5 shows a flowchart illustrating the process of facilitating business interaction in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, a model of a commerce network is obtained (operation 502). The model may include a set of entities, a set of relationships among the entities, a set of interactions related to commerce among the entities, and a set of activities associated with the entities. The entities may include individuals, organizations, and/or representatives of the organizations. Each relationship may be explicit (e.g., declared by one or more entities in the relationship), implicit (e.g., formed by one or more interactions), and/or latent (e.g., based on analysis of the model). Each interaction may be associated with an exchange of an artifact among two or more of the entities. Each activity may then be used to update the other components of the model.

Next, the model is used to enable an interaction among two or more entities from the set of entities independently of a set of endpoints used by the entities to access the commerce network (operation 504). To enable the interaction, a notification associated with the interaction may be generated and routed to one or more of the endpoints based on the model. For example, the notification may be transmitted to an endpoint used by an entity targeted in the interaction to allow the entity to participate in the interaction and/or obtain the artifact associated with the interaction through the endpoint. The notification may also be transmitted to multiple endpoints if multiple entities are targeted in the interaction and more than one endpoint is used by the targeted entities to access the commerce network. Alternatively, the interaction and/or artifact may be routed directly to the targeted entities in lieu of the notification.

The model may then be updated based on an activity associated with the interaction (operation 506). For example, a first entity may create an invoice within an endpoint and specify an email address, phone number, name, and/or other identifying information for a second entity for which the invoice is destined. As a result, the first entity may perform a first activity that initiates an interaction with the second entity and/or establishes a relationship between the first and second entities. Next, the second entity may obtain the invoice from the endpoint and/or commerce network using a notification of the invoice from the commerce network. Consequently, the second entity may perform a second activity that completes the interaction and/or strengthens the relationship.

Finally, the updated model may be used to enable one or more subsequent interactions among the entities (operation 508). Continuing with the above example, the receipt of the invoice by the second entity may enable the payment of the invoice, a request for a revision of the invoice, and/or a question regarding the invoice. Completion of the interaction involving the exchange of the invoice may also establish a relationship between the two entities, thus enabling further messaging and/or sharing of information between the entities outside the context of the invoice.

The model may continue to be updated, and interactions may continue to be enabled during use of the commerce network by the entities. In turn, the updates and interactions may increase the use of the commerce network by the entities and/or the value of the commerce network to the entities. For example, the model and commerce network may streamline a series of interactions across a set of entities in a supply chain and allow the entities to develop relationships and/or other insights among one another. In addition, the commerce network may include a generic endpoint that allows non-registered entities to easily interact with other entities through the commerce network while providing opportunities for the non-registered entities to register with and/or join the commerce network.

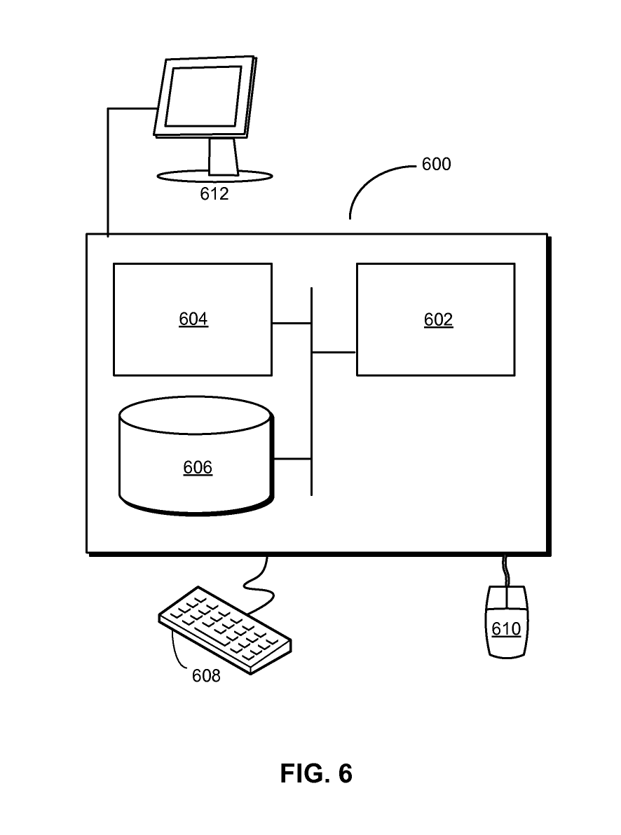

FIG. 6 shows a computer system 600 in accordance with an embodiment. Computer system 600 may correspond to an apparatus that includes a processor 602, memory 604, storage 606, and/or other components found in electronic computer systems. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, FIG. 6 provides a system for facilitating business interaction. The system may include a modeling apparatus that provides a model of a commerce network. The model may include a set of entities, a set of relationships among the entities, a set of interactions related to commerce among the entities, and a set of activities associated with the entities. The system may also include a management apparatus that uses the model to enable an interaction among two or more entities from the set of entities independently of a set of endpoints used by the entities to access the commerce network. The modeling apparatus may also update the model based on an activity associated with the interaction, and the management apparatus may use the updated model to enable one or more subsequent interactions among the two or more entities.

In addition, one or more components of computer system 600 may be remotely located and connected to the other components over a network. Portions of the present embodiments (e.g., modeling apparatus, management apparatus, endpoints, entities, etc.) may also be located on different nodes of a distributed system that implements the embodiments. For example, the present embodiments may be implemented using a cloud computing system that facilitates business interaction among a set of remote entities through a set of endpoints.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating business interaction, comprising:
obtaining a model of a commerce network comprising a set of entities, a set of relationships among the entities, a set of interactions related to commerce among the entities, and a set of activities associated with the entities; and
using the model to enable an interaction among two or more entities from the set of entities independently of a set of endpoints used by the entities to access the commerce network.

2. The computer-implemented method of claim 1, further comprising:
updating the model based on an activity associated with the interaction.

3. The computer-implemented method of claim 2, further comprising:
using the updated model to enable one or more subsequent interactions among the two or more entities.

4. The computer-implemented method of claim 1, wherein enabling the interaction among the two or more entities involves at least one of:
generating a notification associated with the interaction;
routing the notification to one or more of the endpoints based on the model; and
routing the interaction to the one or more of the endpoints based on the model.

5. The computer-implemented method of claim 1, wherein the set of entities comprises at least one of:
an individual;
an organization; and
a representative of the organization.

6. The computer-implemented method of claim 1, wherein the set of relationships comprises at least one of:
an explicit relationship;
an implicit relationship; and
a latent relationship.

7. The computer-implemented method of claim 6,
wherein the explicit relationship is declared by an entity from the set of entities,
wherein the implicit relationship is formed by one or more of the interactions, and
wherein the latent relationship is based on analysis of the model.

8. The computer-implemented method of claim 1, wherein the set of endpoints comprises at least one of:
a consumer endpoint;
a business endpoint;
an external endpoint; and
a generic endpoint.

9. The computer-implemented method of claim 8, wherein the generic endpoint enables access to the commerce network by a non-registered entity.

10. The computer-implemented method of claim 1, wherein the interaction is associated with an exchange of an artifact among the two or more entities.

11. A system for facilitating business interaction, comprising:
a modeling apparatus configured to provide a model of a commerce network comprising a set of entities, a set of relationships among the entities, a set of interactions related to commerce among the entities, and a set of activities associated with the entities; and
a management apparatus configured to use the model to enable an interaction among two or more entities from the set of entities independently of a set of endpoints used by the entities to access the commerce network.

12. The system of claim 11, wherein the modeling apparatus is further configured to:
update the model based on an activity associated with the interaction.

13. The system of claim 12, wherein the management apparatus is further configured to:
use the updated model to enable one or more subsequent interactions among the two or more entities.

14. The system of claim 11, wherein enabling the interaction among the two or more entities involves at least one of:
generating a notification associated with the interaction;
routing the notification to one or more of the endpoints based on the model; and
routing the interaction to the one or more of the endpoints based on the model.

15. The system of claim 11, wherein the set of relationships comprises at least one of:
an explicit relationship declared by an entity from the set of entities;
an implicit relationship formed by one or more of the interactions; and
a latent relationship based on analysis of the model.

16. The system of claim 11, wherein the set of endpoints comprises at least one of:
a consumer endpoint;
a business endpoint;
an external endpoint; and
a generic endpoint.

17. A computer-readable storage medium storing instructions that when executed by a computer cause the computer to perform a method for facilitating business interaction, the method comprising:
obtaining a model of a commerce network comprising a set of entities, a set of relationships among the entities, a set of interactions related to commerce among the entities, and a set of activities associated with the entities; and
using the model to enable an interaction among two or more entities from the set of entities independently of a set of endpoints used by the entities to access the commerce network.

18. The computer-readable storage medium of claim 17, the method further comprising:
updating the model based on an activity associated with the interaction; and
using the updated model to enable one or more subsequent interactions among the two or more entities.

19. The computer-readable storage medium of claim 17, wherein enabling the interaction among the two or more entities involves at least one of:
generating a notification associated with the interaction;
routing the notification to one or more of the endpoints based on the model; and
routing the interaction to the one or more of the endpoints based on the model.

20. The computer-readable storage medium of claim 17, wherein the set of relationships comprises at least one of:
an explicit relationship declared by an entity from the set of entities;
an implicit relationship formed by one or more of the interactions; and
a latent relationship based on analysis of the model.

21. The computer-readable storage medium of claim 17, wherein the set of endpoints comprises at least one of:
a consumer endpoint;
a business endpoint;
an external endpoint; and
a generic endpoint.

22. The computer-readable storage medium of claim 17, wherein the generic endpoint enables access to the commerce network by a non-registered entity.
